(19) United States
(12) Patent Application Publication
(10) Pub. No.: US 2021/0278874 A1
(43) Pub. Date: Sep. 9, 2021

(54) SEGMENTED PERSONAL ELECTRONIC DEVICE CANOPY

(71) Applicant: Renee Swain, Westland, MI (US)

(72) Inventor: Renee Swain, Westland, MI (US)

(21) Appl. No.: 16/812,491

(22) Filed: Mar. 9, 2020

(51) Int. Cl. G06F 1/16; H04B 1/3888

(52) U.S. Cl. CPC G06F 1/1603; H04B 1/3888

(57) ABSTRACT

A segmented personal electronic device canopy is comprised of a rotational frame, a flexible covering, two rotational joints, and connection for attaching the segmented personal electronic device canopy to a personal electronic device. The rotational frame is comprised of a plurality of u-shaped rib. Each u-shaped is comprised of a transverse member and two radial members. Each radial member of each u-shaped rib is connected to a rotational joint. The flexible covering covers the rotational frame. The rotational frame can be opened or closed. In the open position, the rotational frame will prevent sunlight from striking the display screen of the personal electronic device.

### FIELD OF INVENTION

This invention relates to cellphone accessories. Specifically, this invention is an accessory that shades a cellphone display during times of intense sunlight.

### BACKGROUND OF INVENTION

Cellphones, pads, and tablets (“Portable Electronic Devices” or “PEDs”) are ubiquitous. However, using them outside can be challenging. Almost everyone has tried to use a PED at the beach or in a park or even on a city street in the bright sunlight. Sunlight obscures the screen of a PED, making it difficult or impossible to use in certain situations. The screen can be washed out, the text hard to read.

Users of PEDs have various strategies for using them out of doors. Some users skulk in the shade, under awnings or in the shadow of buildings. Some users turn up the brightness on the display, which greatly affects the battery life, and provides a substantially sub-optimal experience. With the PED screen turned up to full brightness on a sunny day, the experience is still washed out and hard to read. Sunglasses or on-screen filters do not solve the problem, either.

These various methods all fail for one simple reason: the luminance of the sun is orders of magnitude greater than the luminance of a display screen on a Portable Electronic Device. Luminance is the visible light flux radiated from a point light source per unit solid angle and per unit projected area perpendicular to the specified direction. The only viable solution is to provide a temporary shade element which limits the sunlight projected perpendicular onto the screen of a PED.

The current offerings are all substandard for one reason or another. Some provide a shade which is but a fraction of that which is needed. Some require that the PED be held at a specific angle. What the market is looking for is a temporary sunscreen that can shade the screen of a PED under almost all conditions. The solution should be inexpensive, easily removable, and usable with any PED.

### SUMMARY OF THE INVENTION

This summary is intended to disclose the present invention a segmented personal electronic device canopy. The segmented personal electronic device canopy can be a stand-alone device, or it can be integrated into a cellphone case. The segmented personal electronic device canopy can fit along the short-edge of a personal electronic device or along the long-edge of a personal electronic device. The segmented personal electronic device canopy can be fitted for a cellphone, tablet, or pad.

The segmented personal electronic device canopy has two identical rotational joints disposed opposite one another on the same rotational axis. The segmented personal electronic device canopy has a rotational frame constructed from a plurality of u-shaped ribs. One u-shaped rib, disposed most forward with respect to the screen of the personal electronic device, is designated the front terminal rib. The front terminal rib has a front terminal transverse member and two front terminal radial members. Each rib has a transverse member and two radial members. Each transverse member has two ends. At one end, the transverse member attaches orthogonally to a first radial member. At a second end, the transverse member attaches orthogonally to a second radial member. The two radial members being parallel with one another. Each of the two radial members attaches to a rotational joint. Each rib is substantially u-shaped and the transverse members and two radial members can be continuous. The connection between the transverse members and two radial members can be filleted. At a minimum, the segmented personal electronic device canopy has a front terminal rib and a rear terminal rib.

The rotational frame of the segmented personal electronic device canopy is covered with a flexible material. The flexible covering is attached to the transverse members and radial members of each of the plurality of u-shaped ribs. The segmented personal electronic device canopy has at least one pair of adjacent ribs. Each adjacent pair of ribs has an adjacent pair of transverse members, and two adjacent pairs of radial members. The flexible covering covers the rotational frame between each set adjacent transverse members. The flexible covering is affixed to each transverse member. The flexible covering covers the rotational frame between each set of adjacent radial members. The flexible covering is affixed to each radial member. The flexible covering between each set of adjacent transverse members is rectangular while the flexible covering between each set of adjacent radial members is triangular. The flexible covering terminates at the front terminal transverse member by wrapping around the front terminal transverse member. The flexible covering is then affixed with glue or it is sewn into place in order to secure it. The flexible covering limits the travel of the rotational frame.

The rotational joints allow the ribs of the segmented personal electronic device canopy to be rotated into the open or closed position. The segmented personal electronic device canopy can be opened, closed, or partially opened. When opened, the adjacent ribs are rotated as far as possible from one another, being stopped by the tension provided by the flexible covering, which is affixed to each transverse member and each radial member. When closed, the ribs are brought into near proximity with one another, collapsing the segmented personal electronic device canopy. A partially opened configuration is between the opened configuration and the closed configuration. In the closed configuration, the segmented personal electronic device canopy does not block sunlight from hitting the screen.

The transverse ribs and radial ribs can be constructed from a variety of materials including, but not limited to, steel, spring steel, zinc, aluminum, acrylonitrile butadience styrene (“ABS”), polycarbonate (“PC”), polypropylene (“PP”), polyamides (“nylon”), and polyvinyl chloride (“PVC”). The flexible covering is fabricated from a flexible material including, but not limited to, cotton, a polyester-cotton blend, polyester, polyimide, rayon, spandex, aramide fibers, polyimides, and nylon.

The present invention is attached to the cellphone using an integrated cellphone case, or as a stand-alone device.

### BRIEF DESCRIPTION OF THE DRAWINGS

The present invention is illustrated with 10 drawings on 10 sheets.

FIG. 1 is a front view of a cellphone with a case.

FIG. 2 is perspective front view of a cellphone with the present invention integrated into the cellphone case.

FIG. 3 is a perspective front view of a cellphone and case with the present invention attached.

FIG. 4 is a rear view of the cellphone and case with the present invention attached.

FIG. 5 is a perspective front view of an alternative embodiment of the present invention integrated into the cellphone case.

FIG. 6 is a rear view of the cellphone and case with an alternative embodiment of the present invention attached.

FIG. 7 is a rear view of the cellphone and case with an alternative embodiment of the present invention attached.

FIG. 8 is a rear view of the cellphone and case with an alternative embodiment of the present invention attached.

FIG. 9 is a rear perspective view of the cellphone and case with an alternative embodiment of the present invention attached.

### DETAILED DESCRIPTION OF THE DRAWINGS

The following descriptions are not meant to limit the invention, but rather to add to the summary of invention, and illustrate the present invention, a segmented personal electronic device canopy. The present invention is illustrated with a variety of drawings showing the primary embodiment of the present invention, with examples presented of the various form-factors that the present invention can take.

Certain terminology is used in the following description for convenience only and is not limiting. The article “a” is intended to include one or more items, and where only one item is intended the term “one” or similar language is used. To assist in the description of the present invention, words such as short, long, top, bottom, side, upper, lower, front, rear, inner, outer, right and left are used to describe the relative size and orientation of the present invention with respect to the cellphone in the accompanying figures. The terminology includes the words above specifically mentioned, derivatives thereof, and words of similar import.

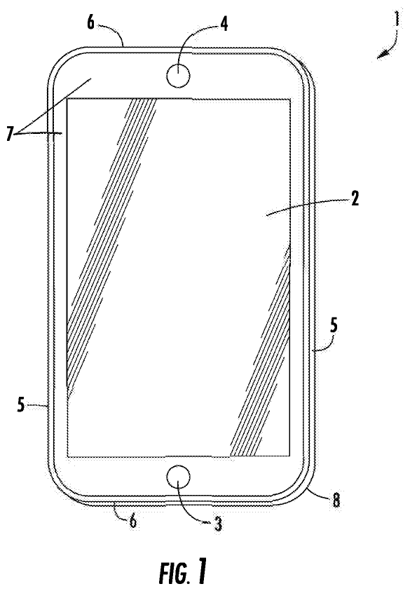

FIG. 1 shows a typical PED 1 and case 8, in this instance, the PED 1 is a cellphone 1. The cellphone 1 has a screen 2, a camera 4, a bezel 7, and, optionally, one or more hard keys 3. The cellphone 1 case 8 completely surrounds the cellphone 1, leaving only the screen 2 and part of the bezel 7 exposed. The case 8 has two relatively longer sides 5 and two relatively shorter sides 6 to properly encompass the cellphone 1. When a user views the screen 2 in bright sunlight, the glare and brightness often make the screen 2 unreadable, because the luminance of the sunlight on the screen overwhelms the screen's 2 brightness. Further, even if the screen 2 is visible in bright sunlight, viewing it becomes quickly fatiguing. Sunglasses are not really a cure to this problem, because sunglasses do not change the amount of ambient light on the screen 2, itself, nor do sunglasses affect the relative luminance between the sunlight and the brightness of the screen 2. Additionally, many polarized sunglasses make the screen 2 more difficult to read, still.

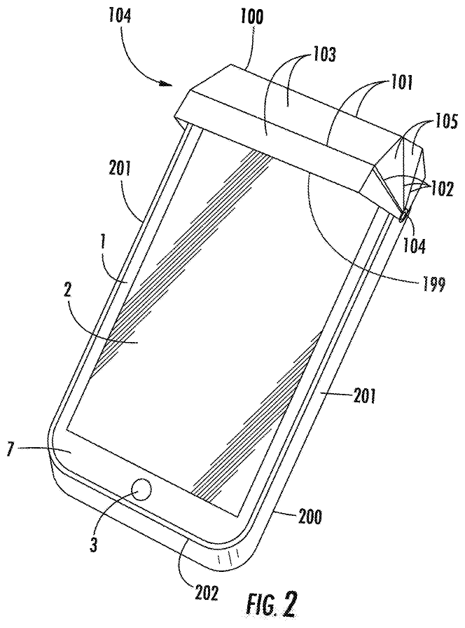

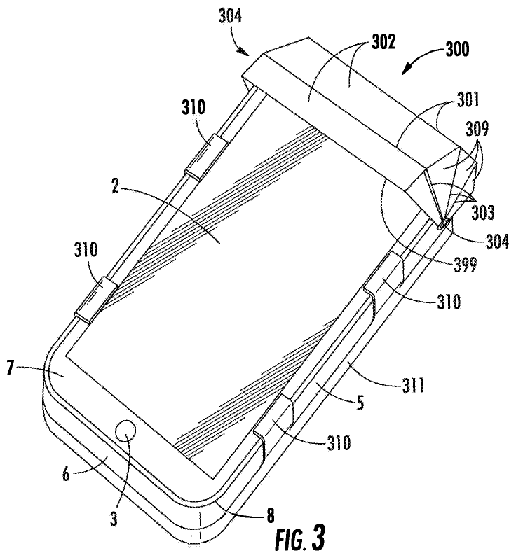

The present invention 100, 300 comes in two main embodiments, shown in FIGS. 2 and 3. In the first main embodiment, shown in FIG. 2, the present invention 100 is integral with a phone case 200. In the second main embodiment, shown in FIG. 3, the present invention 300 temporarily attaches to the shorter side of a PED 1 and case 8. In FIGS. 2 and 3, the PED 1 is a cellphone 1.

In FIG. 2, the segmented personal electronic device canopy 100 has an integral case 200. The integral case 200 surrounds the cellphone 1 like a standard case 8. The integral case 200 is placed on the cellphone 1 in the standard manner. The integral case 200 has two relatively longer sides 201 and two relatively shorter sides 202, in order to properly surround and protect the cellphone 1, just like a standard case 8. Certain parts of the cellphone 1 are visible: the screen 2, the bezel 7, and the hard-key 3. The camera 4 is obscured by the segmented personal electronic device canopy 100.

The segmented personal electronic device canopy 100 has two identical rotational joints 104 disposed opposite one another on the same rotational axis. The segmented personal electronic device canopy 100 has a rotational frame constructed from a plurality of u-shaped ribs 199, 101, 102. Each u-shaped rib 199, 101, 102 has a transverse member 199, 101 and two radial members 102. The transverse members 199, 101 are parallel with the shorter sides 202 of the integral case 200. Each transverse member 199, 101 has two ends. At one end, the transverse member 199, 101 attaches orthogonally to a first radial member 102. At a second end, the transverse member 199, 101 attaches orthogonally to a second radial member 102. The two radial members 102 being parallel with one another. The radial members 102 terminate in the rotational joints 104. Each rib 199, 101, 102 is substantially u-shaped and the transverse members 199, 101 and two radial members 102 can be, and usually are, continuous, being formed from a single piece of metal or polymer. The connection between the transverse members 199, 101 and two radial members 102 can be filleted. One rib 199 is designated the front terminal rib 199, with a front terminal transverse member 199.

The segmented personal electronic device canopy 100 has at least one pair of adjacent ribs 199, 101, 102. Each adjacent pair of ribs 199, 101, 102 has an adjacent pair of transverse members 199, 101, and two adjacent pairs of radial members 102. Each adjacent pair of transverse members 199, 101 supports the transverse portion 103 of the flexible cover, a piece of flexible material 103, which is affixed to each of the transverse members 199, 101. The transverse portion 103 of the flexible covering is rectangular in this embodiment. Each adjacent pair of radial members 102 supports a radial portion 105 of the flexible covering, a piece of flexible material 105, which is triangular in shape 105 in this embodiment. The transverse portion 103 of the flexible covering terminates at the front terminal transverse member 199, by wrapping around the front terminal transverse member 199. The end of the flexible covering is then held in place with glue, or is sewn in place.

The rotational joints 104 allow the ribs 199, 101, 103 of the rotational frame of the segmented personal electronic device canopy 100 to be rotated into the open or closed position. The segmented personal electronic device canopy 100 is shown in its fully opened position in FIG. 2, which allows it to provide shade to the cellphone 1 screen 2. The adjacent ribs 199, 101, 102 can be brought into near proximity with one another, collapsing the segmented personal electronic device canopy 100 into a closed position. In the closed position, the segmented personal electronic device canopy 100 does not block sunlight from hitting the screen 2.

In FIG. 3, the second main embodiment of the segmented personal electronic device canopy 300 is temporarily affixed to a cellphone 1 and case 8. The cellphone case 8 surrounds and protects the cellphone 1. The standard phone case 8 has a relatively longer side 5 and a relatively shorter side 6, in order to properly surround and protect the cellphone 1. Certain parts of the cellphone 1 are visible: the screen 2, the bezel 7, and the hard-key 3. The camera 4 is obscured by the segmented personal electronic device canopy 300.

In this second main embodiment, the segmented personal electronic device canopy 300 temporarily affixes to a cellphone 1 and case 8, with the use of retaining clips 310. The retaining clips 310 extend over the front edge of the case 8 and the bezel 7 of the cellphone 1. The retaining clips 310 extend upward from a base 311.

The segmented personal electronic device canopy 300 has two identical rotational joints 304 disposed opposite one another on the same rotational axis. The segmented personal electronic device canopy 300 has a plurality of u-shaped ribs 399, 301, 303. One u-shaped rib 399 is designated the front terminal rib 399, with a front terminal transverse member 399. Each rib 399, 301, 303 has a transverse member 399, 301 and two radial members 303. The transverse members 399, 301 are parallel to the relatively shorter sides 6 of the cellphone 1 case 8. Each transverse member 399, 301 has two ends. At one end, the transverse member 399, 301 attaches orthogonally to a first radial member 303. At a second end, the transverse member 399, 301 attaches orthogonally to a second radial member 303. The two radial members 303 being parallel with one another. The radial members 303 terminate in the rotational joints 304. Each rib 399, 301, 303 is substantially u-shaped and the transverse members 399, 301 and two radial members 303 can be, and usually are, continuous, being formed from a single piece of metal or polymer. The connection between the transverse members 399, 301 and two radial members 303 can be filleted. One rib 399 is designated the front terminal rib 399, with a front terminal transverse member 399.

The segmented personal electronic device canopy 300 has at least one pair of adjacent ribs 399, 301, 303. Each adjacent pair of ribs 399, 301, 303 has an adjacent pair of transverse members 399, 301, and two adjacent pairs of radial members 303. Each adjacent pair of transverse members 399, 301 supports a transverse portion 302 of the flexible covering, a transverse piece of flexible material 302, which is affixed to each transverse member 399, 301. The transverse portion 302 of the flexible covering is rectangular in shape 302 in this embodiment. Each adjacent pair of radial members 303 supports a radial portion 309 of the flexible covering, a flexible piece of material 309, which is triangular in shape 309 in this embodiment. The transverse portion 302 of the flexible cover terminates at the front terminal transverse member 399 by being wrapped around the front terminal transverse member 399 and being glued or sewed into place.

The rotational joints 304 allow the u-shaped ribs 399, 301, 303 of the rotational frame of the segmented personal electronic device canopy 300 to be rotated into the open or closed position. The segmented personal electronic device canopy 300 is shown in its fully opened position in FIG. 3, which allows it to provide shade to the cellphone 1 screen 2. The adjacent ribs 399, 301, 303 can be brought into near proximity with one another, collapsing the segmented personal electronic device canopy 300 into a closed position. In the closed position, the segmented personal electronic device canopy 300 does not block sunlight from hitting the screen 2.

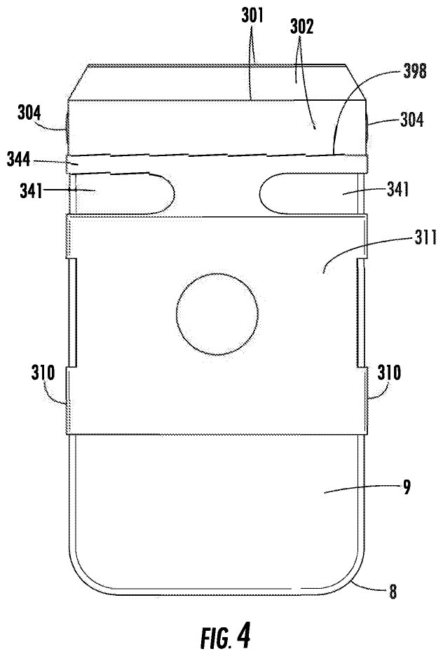

FIG. 4 shows the rear view of the second main embodiment of the segmented personal electronic device canopy 300. The rear 9 of the cellphone case 8 is visible. The retaining clips 310 extend upward from the base 311. The rear of the segmented personal electronic device canopy 300 is visible, showing the rearward-oriented transverse ribs 301 and the rearward-oriented of transverse portion 302 of the flexible covering. The rotational joints 304 are partially visible in this view. A rear terminal rib 398 containing a rear terminal transverse member 398 is visible. The transverse portion 302 of the flexible covering terminating on the rear terminal transverse member 398, will usually be wrapped around the rear terminal transverse member 398 and be glued or sewed into place in order to secure it. The forward portion 344 of the base 311 is obscured by the transverse portions 302 of the flexible covering. The rotational joints 304 are connected to the forward portion 344 of the base 311. Various cut-outs 341 may be made to give the device the required amount of flexibility so that it may be clipped into place.

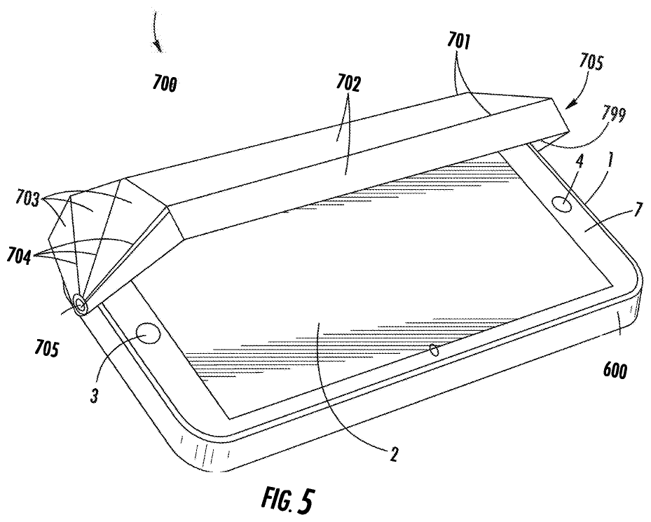

FIG. 5 shows another alternative embodiment with the segmented personal electronic device canopy 700, which is installed along the long-axis 600 of the cellphone 1. This illustration shows the standard features of a cellphone 1: a screen 2, a bezel 7, and hard keys 3, 4. The longitudinally disposed segmented personal electronic device canopy 700 has two identical rotational joints 705 disposed opposite one another on the same rotational axis. The segmented personal electronic device canopy 700 has a plurality of ribs 799, 701, 704. One rib 799 is designated the front terminal rib 799, with a front terminal transverse member 799. Each rib 799, 701, 704 has a transverse member 799, 701 and two radial members 704. The transverse members 799, 701 are parallel to the relatively longer sides 600 of the cellphone 1. Each transverse member 799, 701 has two ends. At one end, the transverse member 799, 701 attaches orthogonally to a first radial member 704. At a second end, the transverse member 799, 701 attaches orthogonally to a second radial member 704. The two radial members 704 being parallel with one another. The radial members 704 terminate in the rotational joints 705. Each rib 799, 701, 704 is substantially u-shaped and the transverse members 799, 701 and two radial members 704 can be, and usually are, continuous, being formed from a single piece of metal or polymer. The connection between the transverse members 799, 701 and two radial members 704 can be filleted. One rib 799 is designated the front terminal rib 799, with a front terminal transverse member 799.

The segmented personal electronic device canopy 700 has at least one pair of adjacent ribs 799, 701, 704. Each adjacent pair of ribs 799, 701, 704 has an adjacent pair of transverse members 799, 701, and two adjacent pairs of radial members 704. Each adjacent pair of transverse members 799, 701 supports a transverse portion 704 of the flexible covering, a piece of flexible material 702, which is affixed to each of the transverse members 799, 701, and which is rectangular in shape 702 in this embodiment. Each adjacent pair of radial members 704 supports a radial portion 703 of the flexible covering, a piece of flexible material 703, which is triangular in shape 703 in this embodiment. A transverse segment 702 of the flexible covering terminating on the front terminal transverse member 799, will usually be wrapped around the front terminal transverse member 799 and be glued or sewed into place in order to secure it.

The rotational joints 705 allow the u-shaped ribs 799, 701, 704 of the rotational frame of the segmented personal electronic device canopy 700 to be rotated into the open or closed position. The segmented personal electronic device canopy 700 is shown in its fully opened position in FIG. 5, which allows it to provide shade to the cellphone 1 screen 2. The adjacent ribs 799, 701, 704 can be brought into near proximity with one another, collapsing the segmented personal electronic device canopy 700 into a closed position. In the closed position, the segmented personal electronic device canopy 700 does not block sunlight from hitting the screen 2.

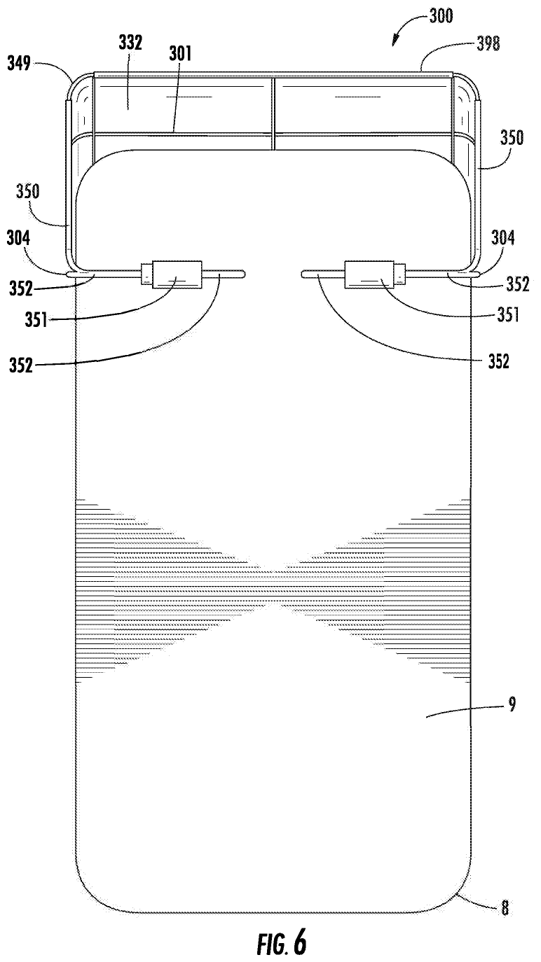

FIG. 6 shows an alternative embodiment for attaching the segmented personal electronic device canopy 300 to a cellphone. The back 9 of the cellphone case 8 provides a substantially flat surface against which a rear retention mechanism 351, 352 can be attached. In this rear view, a back-view of a transverse ribs 301 and the rear of the transverse portions 332 of the flexible covering are shown. The rotational joints 304 are partially visible in this view. A rear terminal transverse member 398 is visible. The transverse portion 332 of the flexible covering terminates by wrapping around the rear terminal transverse member 398. The rear terminal transverse member 398 transitions via fillets 349 into two terminal radial members 350. A retention member 352 is attached orthogonally to the terminus of each terminal radial member 350. A rubber stopper 351 is affixed to each retention members 352. The two rubber stoppers 351 temporarily affix the segmented personal electronic device canopy 300 to the rear 9 of the cellphone case 8.

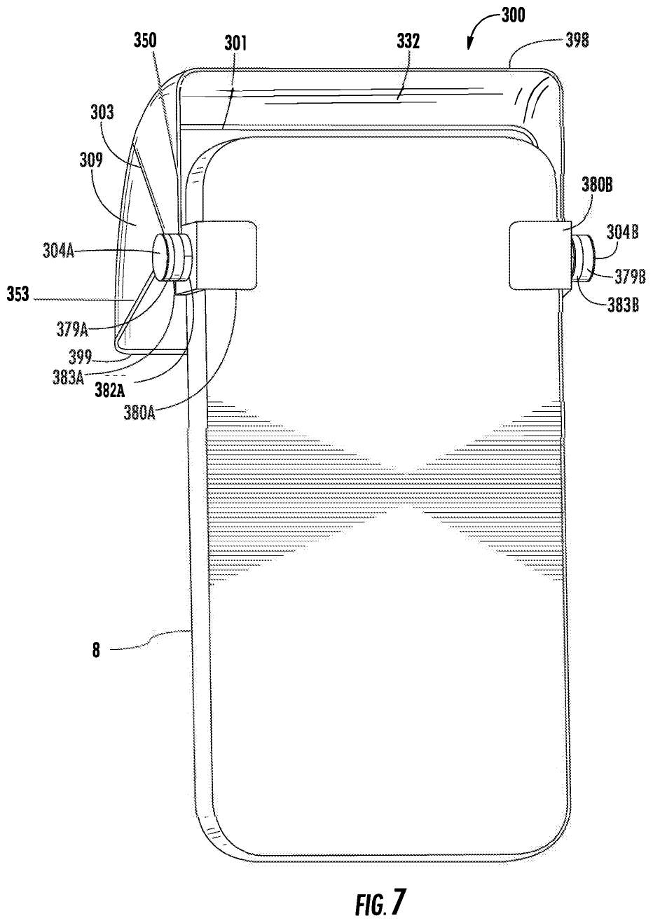

FIG. 7 shows a preferred embodiment for attaching the segmented personal electronic device canopy 300 to a cellphone. In this rear view, a back-view of a transverse ribs 301 and the rear of a transverse portion 332 of the flexible covering are shown. The rotational joints 304A, 304B are partially visible in this view. A rear terminal transverse member 398 is visible. The transverse portion 332 of the flexible covering terminates by wrapping around the rear terminal transverse member 398. A radial rib 303 and a radial portion 309 of the flexible covering are shown. The rear terminal transverse member 398 transitions via fillets 349 into rear terminal radial members 350. A front terminal radial member is shown 353.

The various radial members 350, 303, 353 terminate at a rotational washer 379A, 383A, 382A, respectively, on the left side. Additional ribs and rotational washers can be added to the design. The right side has an equivalent construction but is obscured in this view. This construction allows the radial members 350, 303, 353 to rotate towards one another, and put the segmented personal electronic device canopy 300 into a closed position. The rotational joints 304A, 304B are durably and permanently affixed to a u-bracket 380A, 380B, respectively. The u-bracket 380 fits snuggly around the cellphone case 8. The various transverse ribs 301, 398, 399 are fabricated from spring steel. The segmented personal electronic device canopy 300 can be bent slightly to allow the u-bracket 380A, 380B to fit around the cellphone case 8. The transverse ribs 301, 398, 399 will return to their original their original position, creating a snug fit.

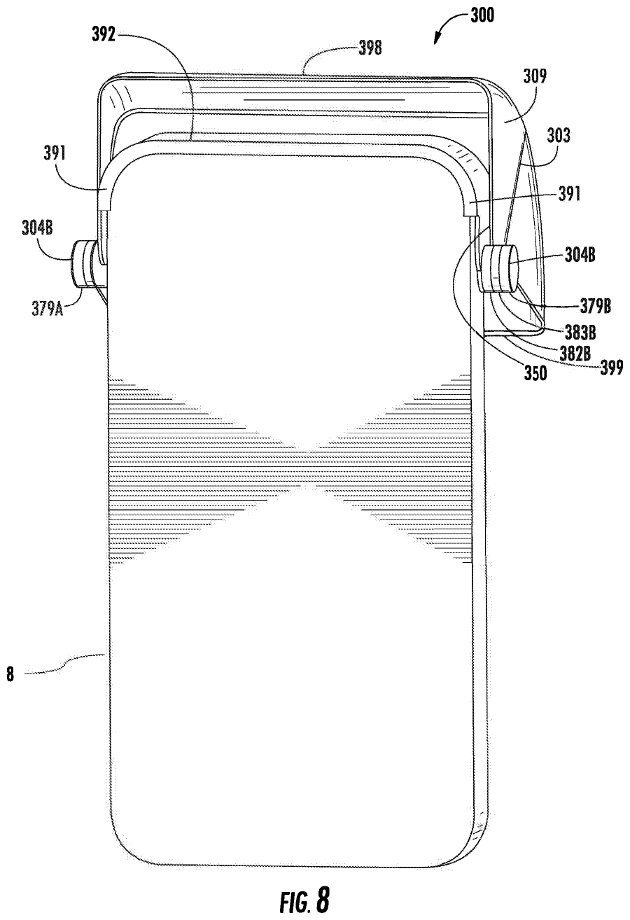

FIG. 8 is an alternative embodiment for temporarily affixing the segmented personal electronic device canopy 300 to the cellphone case 8. In this version, a partial base 391, 392 fits around the cellphone case 8.

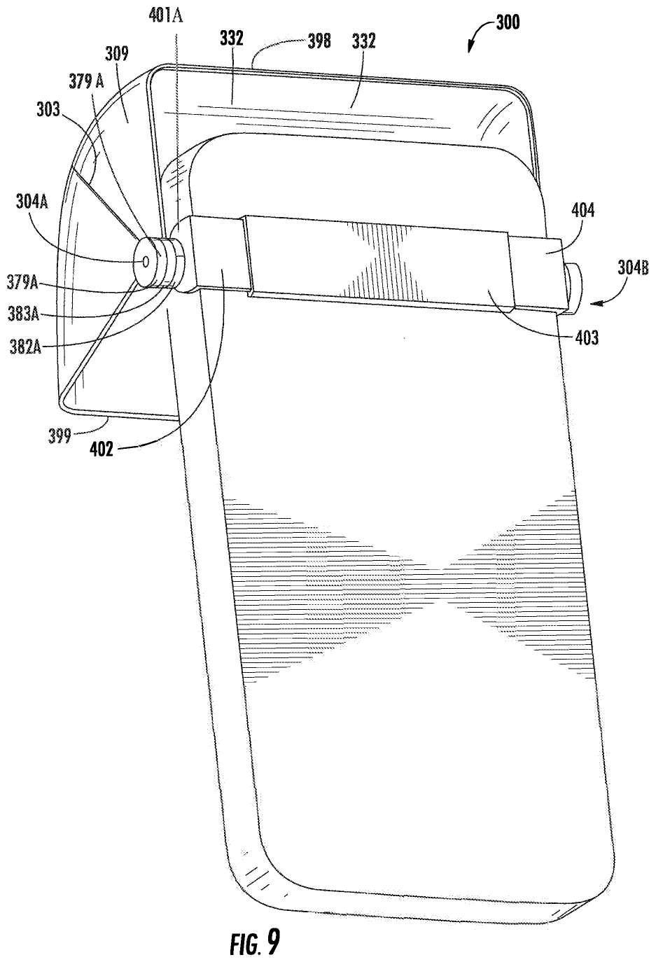

FIG. 9 is an alternative embodiment for temporarily affixing the segmented personal electronic device canopy 300 to the cellphone case 8. The rotational joints 304A, 304B are permanently and durably affixed to a semi-circular connector 401A (401B is obscured in this view). The semi-circular connector 401A orthogonally attaches to a support member 402; likewise, the semi-circular connector 401B orthogonally connects to a separate support member 404. The two support members 402, 404 are captured by a retaining member 403. The retaining member 403 and two support members 402, 404 can be fabricated with mating notches on their mating surfaces that allow the retaining member 403 and two support members 402, 404 to be set to size.

The transverse ribs 101, 199, 301, 398, 399, 701, 799 and radial ribs 102, 303, 704, 350, 353 can be constructed from a variety of materials including, but not limited to, steel, spring steel, zinc, aluminum, acrylonitrile butadience styrene (“ABS”), polycarbonate (“PC”), polypropylene (“PP”), polyamides (“nylon”), and polyvinyl chloride (“PVC”). The flexible covering 103, 105, 302, 309, 702, 703 is fabricated from a flexible material including, but not limited to, cotton, a polyester-cotton blend, polyester, polyimide, rayon, spandex, aramide fibers, polyimides, and nylon.

We claim:

1. A segmented portable electronic device canopy comprising a rotational frame;
two identical rotational joints disposed opposite one another on the same rotational axis;
a flexible covering; and
a connector for temporarily attaching the segmented portable electronic device canopy to a portable electronic device;
wherein the flexible covering covers the rotational frame;
wherein the rotational frame is comprised of a plurality of u-shaped ribs, each u-shaped rib having a transverse member with two ends and two radial members; and
wherein a first radial member for each of the plurality of u-shaped ribs is attached to a first rotational joint and a second radial member for each of the plurality of u-shaped ribs is attached to a second rotational joint.

2. The segmented portable electronic device canopy of claim 1, wherein each of the plurality of u-shaped ribs has a first radial member being orthogonally attached to the first end of the transverse member and a second radial member being orthogonally attached to the second end of the transverse member.

3. The segmented portable electronic device canopy of claim 2, wherein for each of the plurality of u-shaped ribs, the first radial member is parallel to the second radial member.

4. The segmented portable electronic device canopy of claim 3, wherein the flexible covering is adhered to each of the u-shaped ribs.

5. The segmented portable electronic device canopy of claim 4, wherein each u-shaped rib is continuously formed, with the first radial member being filleted with the first end of the transverse member, and with the second radial member being filleted with the second end of the transverse member.

6. The segmented portable electronic canopy of claim 5, wherein a forward-most u-shaped rib is designated the front terminal rib and wherein the flexible covering terminates at the front terminal rib by wrapping around the front terminal rib and being permanently adhered.

7. The segmented portable electronic canopy of claim 6, wherein the flexible covering is permanently adhered with adhesive.

8. The segmented portable electronic canopy of claim 6, wherein the flexible covering is permanently adhered by being sewn in place.

9. The segmented portable electronic canopy of claim 6, wherein a rearward-most u-shaped rib is designated the rear terminal rib and wherein the flexible covering terminates at the rear terminal rib by wrapping around the rear terminal rib and being permanently adhered.

10. The segmented portable electronic canopy of claim 9, wherein the flexible covering is permanently adhered with adhesive.

11. The segmented portable electronic canopy of claim 9, wherein the flexible covering is permanently adhered by being sewn in place.

12. The segmented portable electronic canopy of claim 9, wherein the plurality of u-shaped ribs is fabricated from at least one of steel, spring steel, zinc, aluminum, acrylonitrile butadience styrene (“ABS”), polycarbonate (“PC”), polypropylene (“PP”), polyamides (“nylon”), and polyvinyl chloride (“PVC”).

13. The segmented portable electronic canopy of claim 12, wherein the flexible covering is fabricated from at least one of cotton, a polyester-cotton blend, polyester, polyimide, rayon, spandex, aramide fibers, polyimides, and nylon.

14. The segmented portable electronic canopy of claim 13, wherein the plurality of u-shaped ribs are fabricated from spring steel and the flexible covering is fabricated from a polyester-cotton blend.

15. The segmented portable electronic canopy of claim 14 further comprising a case for a portable electronic device, wherein the rotational joints are permanently affixed to opposing sides of the case.

16. The segmented portable electronic canopy of claim 14 further comprising a base, wherein the base can be temporarily affixed to the case of a portable electronic device.

17. The segmented portable electronic canopy of claim 14 further comprising two u-shaped connectors, wherein the first rotational joint is permanently affixed to a first u-shaped connector and the second rotational is permanently affixed to a second u-shaped connector.

18. The segmented portable electronic canopy of claim 17, wherein the segmented portable electronic canopy can be temporarily affixed to a portable electronic device by bending the u-shaped connectors away from one another and placing one u-shaped connector on each side of the portable electronic device.
